(19) United States
(12) Patent Application Publication
(10) Pub. No.: US 2015/0080503 A1
(43) Pub. Date: Mar. 19, 2015

(54) ENVIRONMENTALLY-FRIENDLY BOARD USING POLYLACTIC ACID AND WOOD FIBER, AND METHOD FOR PREPARING SAME

(71) Applicant: LG Hausys, Ltd., Seoul (KR)

(72) Inventors: Cheng Zhe Huang, Cheongju-si (KR); Chang Won Kang, Cheongju-si (KR); Ji Hyang Son, Daejeon (KR)

(21) Appl. No.: 14/385,889

(22) PCT Filed: Dec. 27, 2012
(86) PCT No.: PCT/KR2012/011583

§ 371 Date: Sep. 17, 2014

(30) Foreign Application Priority Data
Mar. 30, 2012 (KR) 10-2012-0033120

(51) Int. Cl. C08J 5/04; C08J 7/12

(52) U.S. Cl. CPC C08J 5/045; C08J 7/123; C08J 2397/02; C08J 2467/04
USPC 524/14; 264/331.21; 264/485

(57) ABSTRACT

Disclosed are an environmentally-friendly board, which provides the advantages of energy reduction and greenhouse gas reduction and does not emit toxic substances such as toxic gas or endocrine-disrupting chemicals, and a method for preparing same. The environmentally-friendly board, according to the present invention, comprises a biodegradable resin composition including a polylactic acid resin, a crosslinking agent, and wood fiber, and thus provides the advantages of not emitting toxic substances such as toxic gas or endocrine-disrupting chemicals, securing water resistance of a product by PLA crosslinking, and not sticking to a processing tool when heat is applied during processing.

### TECHNICAL FIELD

The present invention relates to an environmentally friendly board and a method for preparing the same. More particularly, the present invention relates to an environmentally friendly board using wood fiber and a polylactic acid resin, which is cross-linked using a composition including polylactic acid, a crosslinking agent and/or a crosslinking aid under certain conditions.

### BACKGROUND ART

Existing medium density fiberboard (MDF) and high density fiberboard (HDF) are wood boards prepared by coating wood fiber with an adhesive obtained through defibration at high temperature, followed by molding and hot-pressing. Since MDF and HDF can be subjected to complicated machining and the like, MDF and HDF are widely used in interior finishing and furniture. Related techniques are disclosed in documents such as Korean Patent Publication No. 10-2000-007214.

However, although the adhesives used in preparation of the fiberboard is mainly composed of a urea-formaldehyde resin or a melamine-urea-formaldehyde resin, exhibit outstanding adhesion, and is low-priced, the adhesives can irritate the eyes, nose and skin as well as causing atopic diseases and bronchial asthma even after curing, and gradually emits formaldehyde, which can cause cancer when inhaled for a long time. In addition, excess melamine intake can result in formation of kidney stones in humans.

Further, melamine, urea, formaldehyde and the like, which are prepared using fossil resources as raw materials, cause continuous rise in price due to deletion of fossil resources, emit large amounts of greenhouse gases while consuming a large amount of energy in the preparation process, and emit a variety of toxic substances, such as endocrine disruptors, toxic gases and the like, when incinerated.

Polylactic acid or polylactide (PLA) is a resin prepared by polymerization of lactic acid, which is obtained by fermentation of starch extracted from renewable plant resources (corn, potatoes, sweet potatoes, and the like), and is an environmentally friendly resin enabling reduction in CO₂ emissions and use of non-renewable energy sources.

However, since PLA is a thermoplastic resin easily hydrolyzed at certain humidity and temperature, there is a drawback in that the board prepared by compounding PLA with wood fiber is vulnerable to moisture and easily clings to a processing tool when heated during processing. Therefore, there is an urgent need for a board using an environmentally friendly resin which is renewable and can minimize emission of toxic substances.

### DISCLOSURE

### Technical Problem

It is an aspect of the present invention to provide an environmentally friendly board and a method for preparing the same. More particularly, the present invention is aimed at providing an environmentally friendly board using wood fiber and a polylactic acid resin, which is cross-linked using a composition including polylactic acid, a crosslinking agent and/or a crosslinking aid under certain conditions, and a method for preparing the same.

### Technical Solution

In accordance with one aspect of the present invention, an environmentally friendly board is formed of a biodegradable resin composition including a polylactic acid resin, a crosslinking agent and wood fiber.

In accordance with another aspect of the present invention, a method for preparing an environmentally friendly board includes: thermoforming a composition, which includes 100 parts by weight of a polylactic acid resin, 50 parts by weight to 300 parts by weight of wood fiber, and 0.001 parts by weight to 10 parts by weight of a crosslinking agent, into a board by heating the composition; and crosslinking the composition that forms the board.

### Advantageous Effects

According to the present invention, since the board uses a polylactic acid resin, which is prepared using renewable plant resources as a raw material, and wood fiber, the board enables reduction in greenhouse gas emissions and conservation of fossil resources, can minimize emission of total volatile organic compounds (TVOCs), such as formaldehyde and the like, as compared with existing MDF, HDF and plywood, and can minimize emission of toxic gases upon combustion thereof.

In addition, according to the present invention, the board can secure water resistance through crosslinking of PLA and does not easily cling to a processing tool when heated during processing.

Further, according to the present invention, the board exhibits better flexural strength than a board using a PLA resin and wood flour.

### [Best Mode]

The features and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof.

Hereinafter, an environmentally friendly board using polylactic acid/wood fiber, and a method for preparing the board according to the present invention, will be described in detail.

Environmentally friendly board using polylactic acid/wood fiber According to one embodiment of the present invention, an environmentally friendly board is formed of a biodegradable resin composition including a polylactic acid resin, a crosslinking agent, and wood fiber.

First, the environmentally friendly board according to the present invention includes polylactic acid resin. Polylactic acid resin is a thermoplastic polyester obtained by polymerization of lactide or lactic acid. For example, polylactic acid resin may be prepared by polymerization of lactic acid or lactide, which is obtained by fermentation of starch extracted from corn, potatoes, and the like. Since corn, potatoes and the like are renewable plant resources, the polylactic acid resin obtained therefrom can effectively solve problems due to depletion of petroleum resources.

In addition, the polylactic acid resin emits a much smaller amount of environmentally toxic substances, such as CO₂ and the like, during use or disposal than petroleum-based materials, such as polyvinyl chloride (PVC) and the like, and is environmentally friendly in that the polylactic acid resin is easily degradable in a natural environment even when discarded.

The polylactic acid resin can be classified into crystalline polylactic acid (c-polylactic acid) resins and amorphous polylactic acid (a-polylactic acid) resins.

According to the present invention, the polylactic acid resin may be any polylactic acid resin without limitation. The polylactic acid resin may include at least one selected from among poly-L-lactic acid, poly-D-lactic acid and poly-L,D-lactic acid.

A urea-formaldehyde resin or a melamine-urea-formaldehyde resin, which is an existing adhesive used in the preparation of fiberboards, can irritate the eyes, nose and skin as well as causing atopic diseases and bronchial asthma even after curing. In addition, there is a problem in that existing adhesives gradually emit formaldehyde, which can cause cancer upon long term exposure. However, the PLA resin according to the present invention exhibits environmentally friendly properties, which can solve all of the aforementioned problems.

According to the present invention, a resin composition for board formation includes wood fiber. The wood fiber may be any wood fiber known in the art and used in interior materials for construction. For example, the wood fiber may be prepared by pulverization of pieces of wood, sawdust, wood shavings, recycled Kraft, recycled corrugated cardboard, recycled newspaper or other forms of recycled paper in a rotary disc-type refining apparatus.

The wood fiber may be present in an amount of 50 parts by weight to 300 parts by weight based on 100 parts by weight of the polylactic acid resin. If the amount of the wood fiber is less than 50 parts by weight, it is difficult for the board to have appearance or texture corresponding to natural wood, and if the amount of the wood fiber is greater than 300 parts by weight, it is difficult for the board to have a desired level of strength and durability due to deterioration in binding strength between wood fibers.

The wood fiber may have a specific gravity of 700 kg/m³ or less in consideration of production cost. If the specific gravity of the wood fiber is greater than 700 kg/m³, there is a problem of increase in production costs.

In addition, the wood fiber may include less than 3.0% by weight (wt %) water in consideration of durability. If the amount of water is greater than 3.0 wt %, there is a problem in that the polylactic acid resin in the prepared environmentally friendly board is easily hydrolyzed due to moisture.

Further, the composition forming the environmentally friendly board according to the invention includes the crosslinking agent for crosslinking of the polylactic acid resin.

Here, the crosslinking agent is used for crosslinking of the polylactic acid resin. The crosslinking agent may be an organic peroxide. Specifically, the crosslinking agent may include dicumyl peroxide (DCP), perbutyl peroxide (PBP), dimethyldi-t-butylperoxyhexane, t-butylethylhexylmonoperoxycarbonate, and the like, without being limited thereto.

The crosslinking agent may be present in an amount of 0.001 parts by weight to 10 parts by weight in the composition based on 100 parts by weight of the polylactic acid resin. If the amount of the crosslinking agent is less than 0.001 parts by weight, there is a problem in that crosslinking is not started, and if the amount of the crosslinking agent is greater than 10 parts by weight, there is processing problems due to thermosetting properties caused by an extremely high degree of crosslinking.

According to the present invention, the biodegradable resin composition may further include the crosslinking aid in addition to the crosslinking agent.

First, the crosslinking aid facilitates crosslinking. The crosslinking aid may be triallyl isocyanurate (TAIC), without being limited thereto.

Here, the crosslinking aid may be present in an amount of 1.0 part by weight or less based on 100 parts by weight of the polylactic acid resin. If the amount of the crosslinking aid is greater than 1.0 part by weight, the polylactic acid resin can be converted into a thermosetting resin or a resin, which is difficult to process due to excessive crosslinking.

According to the present invention, the environmentally friendly board exhibits excellent water resistance and processability due to crosslinking of the polylactic acid resin by the crosslinking agent. Hereinafter, a method for preparing the environmentally friendly board according to the present invention will be described in detail.

Method for Preparing Environmentally Friendly Board Using Polylactic Acid/Wood Fiber

According to one embodiment of the invention, a method for preparing an environmentally friendly board includes: thermoforming a composition, which includes 100 parts by weight of a polylactic acid resin, 50 parts by weight to 300 parts by weight of wood fiber, and 0.001 parts by weight to 10 parts by weight of a crosslinking agent, into a board by heating the composition; and crosslinking the composition that forms the board.

First, according to the present invention, the composition including the polylactic acid resin, the wood fiber and the crosslinking agent is heated to a certain temperature for thermoforming the composition into a board.

Thermoforming may be performed at a temperature from 100° C. to 200° C. If the thermoforming temperature is less than 100° C., there is a problem in that a molded article is not formed due to no gelling of the polylactic acid, and if the thermoforming temperature is greater than 200° C., there is a problem in that the board suffers from deterioration in strength due to pyrolysis of the polylactic acid.

Next, the process of crosslinking the composition is performed.

In crosslinking of the composition, the composition may be cross-linked by heating the board to a temperature higher than the thermoforming temperature.

The temperature for crosslinking of the composition is higher than the thermoforming temperature, and may be from about 100° C. to about 250° C. Here, crosslinking of the polylactic acid resin is started by decomposition of the crosslinking agent included in the composition into radicals. Here, an oven at a certain temperature may be used.

In addition, in crosslinking of the composition, the composition may be cross-linked by electron beam irradiation on the board.

Electron beam irradiation may be performed at an irradiation dose from 10 kGy to 100 kGy, without being limited thereto. If the irradiation dose is less than 10 kGy, there is a problem in that crosslinking is not properly performed, and if the irradiation dose is greater than 100 kGy, the polylactic acid resin can suffer from decomposition due to excessive crosslinking.

The method according to the present invention provides an environmentally friendly board that can secure water resistance through crosslinking of PLA and does not easily cling to a processing tool when heated during processing. The environmentally friendly board prepared by the method exhibits better flexural strength than a board using a PLA resin and wood flour.

Preparation of Boards According to Examples and Comparative Examples

Hereinafter, the present invention will be explained in more detail with reference to some examples. However, it should be understood that these examples are provided for illustration only and are not to be in any way construed as limiting the present invention.

A description of details apparent to those skilled in the art will be omitted for clarity.

### EXAMPLE 1

0.4 wt % of t-butyl-2-ethylhexylmonoperoxycarbonate corresponding to a crosslinking agent and 59.6 wt % of wood fiber were mixed with 40 wt % of a crystalline polylactic acid resin, thereby preparing a biodegradable resin composition.

Next, the composition was subjected to thermoforming into a board at 120° C., followed by crosslinking using a press at 180° C., thereby preparing an environmentally friendly board.

### EXAMPLE 2

0.3 wt % of t-butyl-2-ethylhexylmonoperoxycarbonate corresponding to a crosslinking agent, 0.1 wt % of triallyl isocyanurate corresponding to a crosslinking aid and 59.6 wt % of wood fiber were mixed with 40 wt % of a crystalline polylactic acid resin, thereby preparing a biodegradable resin composition.

Next, an environmentally friendly board was prepared in the same manner as in Example 1.

### EXAMPLE 3

An environmentally friendly board was prepared in the same manner as in Example 2 except that dimethyldi-t-butylperoxyhexane was used as a crosslinking agent.

### COMPARATIVE EXAMPLE 1

A board was prepared in the same manner as in Example 1 except that a crosslinking agent and a crosslinking aid were not used.

### COMPARATIVE EXAMPLE 2

A board was prepared in the same manner as in Example 1 except that wood flour was used instead of the wood fiber.

Evaluation

The boards of Examples and Comparative Examples were evaluated as to flexural strength. Results are shown in Table 1.

TABLE 1

| | | | | Comparative | Comparative |
|---|---|---|---|---|---|
| | Example 1 | Example 2 | Example 3 | Example 1 | Example 2 |
| Flexural strength (kgf/mm²) | 10.4 | 10.8 | 10.6 | 2.1 | 4.2 |

From the evaluation results, it could be seen that the environmentally friendly board according to the present invention exhibited excellent properties by crosslinking the polylactic acid resin and wood fiber. Conversely, it could be seen that the boards prepared in Comparative Examples exhibited poorer flexural strength than the boards prepared in Examples since the boards of Comparative Examples were not cross-linked via the crosslinking agent or included the wood flour instead of the wood fiber.

Although the present invention has been described with reference to some embodiments, it should be understood that the foregoing embodiments are provided for illustrative purposes only, and that various modifications, changes, alterations, and equivalent embodiments can be made by those skilled in the art without departing from the spirit and scope of the invention. Therefore, the scope of the invention should be limited only by the accompanying claims and equivalents thereof.

1. An environmentally friendly board formed of a biodegradable resin composition comprising a polylactic acid resin, a crosslinking agent, and wood fiber.

2. The board according to claim 1, wherein the biodegradable resin composition comprises 0.001 parts by weight to 10 parts by weight of the crosslinking agent and 50 parts by weight to 300 parts by weight of the wood fiber based on 100 parts by weight of the polylactic acid resin.

3. The board according to claim 2, wherein the crosslinking agent comprises at least one organic peroxide selected from among dicumyl peroxide (DCP), perbutyl peroxide (PBP), dimethyldi-t-butylperoxyhexane, t-butylethylhexylmonoperoxycarbonate, and 1,1 -di(t-butylperoxy)-3 ,3,5 -trimethylcyclohexane.

4. The board according to claim 1, wherein the wood fiber has a specific gravity of 700 kg/m³ or less.

5. The board according to claim 1, wherein the wood fiber comprises less than 3.0 wt % of water.

6. The board according to claim 1, wherein the composition further comprises a crosslinking aid.

7. The board according to claim 6, wherein the crosslinking aid is present in an amount of 1.0 part by weight or less based on 100 parts by weight of the polylactic acid resin.

8. A method for preparing an environmentally friendly board, comprising:
thermoforming a composition into a board by heating the composition, the composition comprising 100 parts by weight of a polylactic acid resin, 50 parts by weight to 300 parts by weight of wood fiber, and 0.001 parts by weight to 10 parts by weight of a crosslinking agent; and
crosslinking the composition that forms the board.

9. The method according to claim 8, wherein the composition is cross-linked by heating the board to a temperature higher than thermoforming temperature.

10. The method according to claim 8, wherein the composition is cross-linked by electron beam irradiation on the board.

11. The method according to claim 10, wherein electron beam irradiation is performed at an irradiation dose from 10 kGy to 100 kGy.
